(19) United States
(12) Patent Application Publication
(10) Pub. No.: US 2013/0169576 A1
(43) Pub. Date: Jul. 4, 2013

(54) TOUCH DISPLAY PANEL

(71) Applicants: Dongguan Masstop Liquid Crystal Display Co., Ltd., Dongguan City (CN); WINTEK CORPORATION, Taichung City (TW)

(72) Inventors: Po-Hsien Wang, Taichung City (TW); Jen-Yen Chou, Taichung City (TW); Chen-Hao Su, Taichung City (TW); Yu-Ting Chen, Taoyuan County (TW)

(73) Assignees: WINTEK CORPORATION, Taichung City (TW); DONGGUAN MASSTOP LIQUID CRYSTAL DISPLAY CO., LTD., Dongguan City (CN)

(21) Appl. No.: 13/733,910

(22) Filed: Jan. 4, 2013

(30) Foreign Application Priority Data
Jan. 4, 2012 (TW) 101100337

(51) Int. Cl. G09G 5/00; G06F 3/041

(52) U.S. Cl. CPC G09G 5/00; G06F 3/041
USPC 345/173

(57) ABSTRACT

A touch display panel includes a display panel, a plurality of touch sensing devices, and a touch driver circuit. The display panel includes an array substrate. The touch driver circuit is disposed on the array substrate. The touch driver circuit is electrically connected to the touch sensing devices, and the touch driver circuit is employed to provide at least one scan driving signal to the touch sensing devices.

### BACKGROUND OF THE INVENTION

1. Field of the Invention

The present invention relates to a touch display panel, and more particularly, to a touch display panel having a touch driver circuit disposed on an array substrate.

2. Description of the Prior Art

In recent years, touch sensing technologies have developed flourishingly, and electronic products, such as mobile phones, GPS navigator systems, tablet PCs, personal digital assistances (PDA), and laptop PCs, which are integrated with a touch sensing function, are commercialized accordingly. In the electronic products mentioned above, display panels are mainly used to be integrated with the touch sensing function. In other words, the display panels are replaced by the touch display panels. According to differences in structure designs, the touch display panels may include an out-cell type touch display panel, an in-cell type touch display panel, and an on-cell type touch display panel. In the out-cell type touch display panel, an independent touch panel is attached to a normal display panel. In the in-cell type touch display panel and the on-cell type touch display panel, touch sensing devices are disposed directly on an inner surface or an outer surface of a substrate in the display panel. In the conventional touch display panels, which include the out-cell type touch display panel, the in-cell type touch display panel, and the on-cell type touch display panel, touch driver ICs are required to transmit and receive touch signals. The design complexity of the touch driver IC may become higher in large size touch display panels or touch display panels with higher touch resolution, and the relative manufacturing cost may also be increased.

### SUMMARY OF THE INVENTION

It is one of the objectives of the present invention to provide a touch display panel. A touch driver circuit is disposed on an array substrate, and the purposes of design simplification of the touch driver IC and cost reduction of the touch driver IC may be accordingly achieved.

To achieve the purposes described above, a preferred embodiment of the present invention provides a touch display panel. The touch display panel includes a display panel, a plurality of touch sensing devices, and a touch driver circuit. The display panel includes an array substrate. The touch driver circuit is disposed on the array substrate. The touch driver circuit is electrically connected to the touch sensing devices, and the touch driver circuit is employed to provide at least one scan driving signal to the touch sensing devices.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 and FIG. 2 are schematic diagrams illustrating a touch display panel according to a first preferred embodiment of the present invention.

FIGS. 3-5 are schematic diagrams illustrating a touch driving method of the touch display panel according to the first preferred embodiment of the present invention.

FIG. 6 is a schematic diagram illustrating a touch display panel according to a second preferred embodiment of the present invention.

FIG. 7 is a schematic diagram illustrating a touch display panel according to a third preferred embodiment of the present invention.

FIG. 8 is a schematic diagram illustrating a touch display panel according to a fourth preferred embodiment of the present invention.

FIG. 9 is a schematic diagram illustrating a touch display panel according to a fifth preferred embodiment of the present invention.

### DETAILED DESCRIPTION

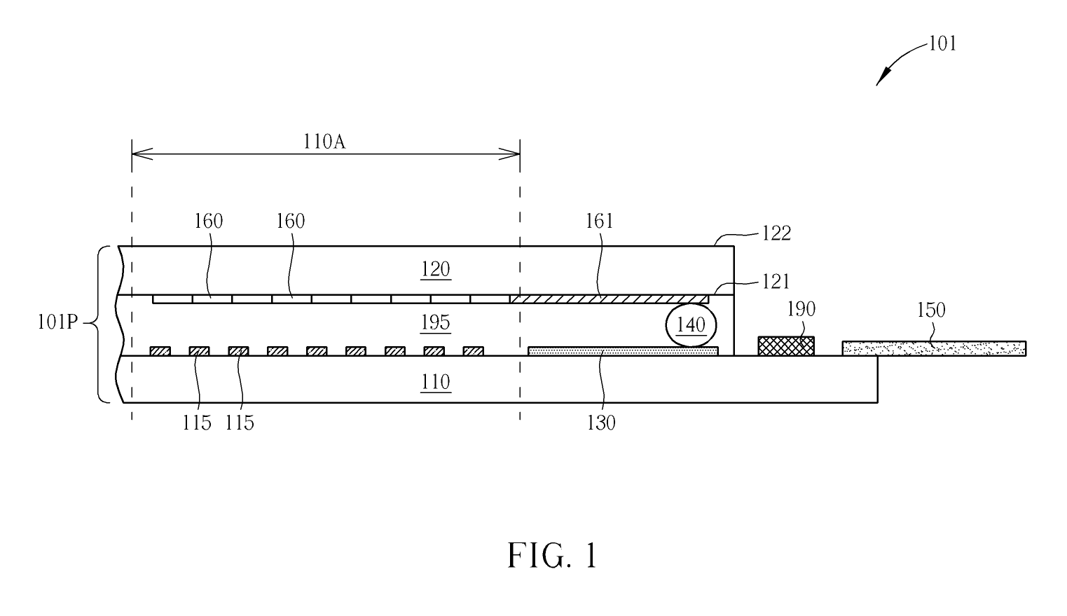

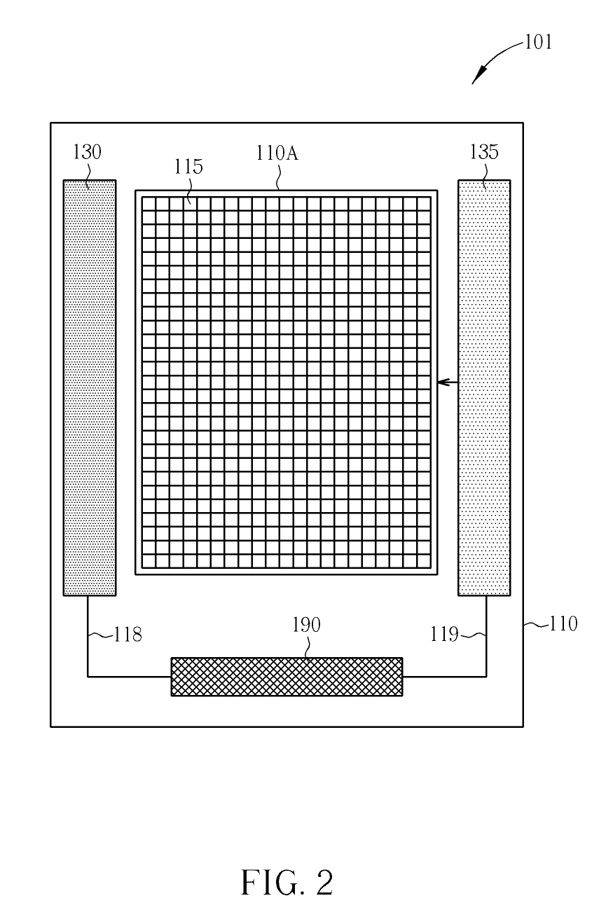

Please refer to FIG. 1 and FIG. 2. FIG. 1 and FIG. 2 are schematic diagrams illustrating a touch display panel according to a first preferred embodiment of the present invention. FIG. 1 is a lateral view diagram, and FIG. 2 is a top-view diagram. Please note that the figures are only for illustration and the figures may not be to scale. The scale may be further modified according to different design considerations. As shown in FIG. 1 and FIG. 2, the first preferred embodiment of the present invention provides a touch display panel 101. The touch display panel 101 includes a display panel 101P, a plurality of touch sensing devices 160, at least one connecting device 140, and a touch driver circuit 130. The display panel 101P includes an array substrate 110, a counter substrate 120, and a display medium layer 195. The counter substrate 120 is disposed oppositely to the array substrate 110. The counter substrate 120 has an inner surface 121 and an outer surface 122. The inner surface 121 faces the array substrate 110, and the outer surface 122 faces the opposite direction from the array substrate 110. The touch sensing devices 160 are disposed on the inner surface 121 of the counter substrate 120. The touch driver circuit 130 is disposed on the array substrate 110. The connecting device 140 is disposed between the array substrate 110 and the counter substrate 120. In this embodiment, the touch driver circuit 130 is electrically connected to the touch sensing devices 160 through the connecting device 140. In other words, the touch driver circuit 130 is employed to provide at least one scan driving signal to the touch sensing devices 160 through the connecting device 140. Additionally, the array substrate 110 in this embodiment may have an active display region 110A, and the touch driver circuit 130 is preferably disposed outside the active display region 110A. More specifically, the touch display panel 101 in this embodiment may further include at least one conductive circuit 161 disposed on the inner surface 121 of the counter substrate 120. The conductive circuit 161 is electrically connected to the touch sensing devices. Therefore, the touch driver circuit 130 may be electrically connected to the touch sensing devices 160 through the connecting device 140 and the conductive circuit 161 sequentially and provides the scan driving signal to the touch sensing devices 160. It is worth noting that the conductive circuit 161 may include transparent conductive materials such as indium tin oxide (ITO), indium zinc oxide (IZO), and aluminum zinc oxide (AZO), or other appropriate non-transparent conductive materials such as silver (Ag), silver nanowires, aluminum (Al), copper (Cu), magnesium (Mg), molybdenum (Mo), a stack layer of the above-mentioned materials, or an alloy of the above-mentioned materials, but not limited thereto. Additionally, the conductive circuit 161 and the touch sensing devices 160 may be made of an identical material or be made of different materials. When the conductive circuit 161 and the touch sensing devices 160 are made of the same material in an identical manufacturing process, the conductive circuit 161 may also be regarded as an extending part of the touch sensing device 160 in a surrounding region of the touch display panel 101. It is worth noting that, in this embodiment, the amount and the allocation of the connecting device 140 may be further modified according to different design considerations so as to effectively transmit the scan driving signal from the touch driver circuit 130 to each of the touch sensing devices 160. In addition, the structure of the connecting device 140 may be similar to a conductive silver paste which is generally used to connect common signals from an array substrate and a color filter in the conventional liquid crystal display device, but not limited thereto.

In the present invention, the array substrate 110 may include a plurality of display control units 115 disposed in the active display region 110A, and the display control units 115 are employed to drive the display medium layer 195 to present display images. Additionally, the array substrate 110 may include an amorphous silicon thin film transistor array substrate, a poly silicon thin film transistor array substrate, or an oxide semiconductor thin film transistor array substrate, but the present invention is not limited to this, and other appropriate thin film transistor substrates may also be employed in the present invention. In other words, the display control units 115 disposed in the active display region 110A may include amorphous silicon thin film transistors, poly silicon thin film transistors, oxide semiconductor thin film transistors, or other appropriate control units. It is worth noting that the touch driver circuit 130 and the display control units 115 in the present invention are preferably formed during the same manufacturing processes. In other words, the touch driver circuit 130 may be formed on the array substrate 110 by a conventional array process thereby avoiding increasing the manufacturing costs. Therefore, the touch driver circuit 130 of the present invention may also include amorphous silicon semiconductor devices, poly silicon semiconductor devices, oxide semiconductor devices, or other appropriate semiconductor devices. It is worth noting that the touch driver circuit 130 of the present invention is preferably disposed outside the active display region 110A in the array substrate 110, and designs of devices and circuits within the active display region 110A may not be influenced accordingly. Additionally, the touch display panel 101 in this embodiment may further include a display driving circuit 135 disposed on the array substrate 110 so as to drive each of the display control units 115, but not limited thereto. The display driving circuit 135 may also be formed on the array substrate 110 by the conventional array process thereby avoiding increasing the manufacturing costs. In the present invention, the display medium layer 195 may include a liquid crystal material, an organic light emitting material, an electrophoresis display material, or an e-ink material according to different design considerations, but not limited thereto. In other words, the display panel 101P in this embodiment may include a liquid crystal display panel, an organic electroluminescent display panel, or an electronic paper display panel. It is appreciated that the touch sensing devices 160 may also be disposed on the array substrate 110 in other preferred embodiment of the present invention, i.e. the touch sensing devices 160, the display control units 115, and the touch driver circuit 130 may be all disposed on the array substrate 110 so as to further simplify the manufacturing process.

As shown in FIG. 1 and FIG. 2, the touch display panel 101 in this embodiment may further include a driver integrated circuit (IC) 190, and the display panel 101P may further include a circuit board 150. In this embodiment, the driver IC 190 may be disposed on the array substrate 110, the driver IC 190 may be electrically connected to the touch driver circuit 130 through a conductive line 118 in the array substrate 110, and signals generated from the driver IC 190 may be transmitted to the touch driver circuit 130 and be processed in the touch driver circuit 130. Additionally, the driver IC 190 may also be electrically connected to the display driving circuit 135 through a conductive line 119 in the array substrate 110, and the signals generated from the driver IC 190 may also be transmitted to the display driving circuit 135 and be processed in the display driving circuit 135. It is appreciated that the touch driver circuit 130 is preferably used to process touch transmitting signals (Tx) and passes the touch transmitting signals to each of the touch sensing devices 160, but the present invention is not limited to this, and the touch driver circuit 130 may also be modified to process the touch transmitting signals and touch receiving signals (Rx) according to different design considerations. In addition, the circuit board 150 is electrically connected to the array substrate 110 so as to input signals to the array substrate 110. The circuit board 150 in this embodiment may include a flexible printed circuit (FPC), a chip on film (COF) circuit board, or other appropriate circuit boards. It is worth noting that, the driver IC 190 may be employed to generate and process signals for the touch function and the driver IC 190 may also be employed to generate and process signals for the display function. In other words, the driver IC 190 may be used only to drive the touch sensing devices 160, or the driver IC 190 may be used to drive both the touch sensing devices 160 and the display control units 115, but not limited thereto. Additionally, in the touch display panel 101, an outer surface 122 of the counter substrate 120 may be regarded as a touch sensing surface because the touch sensing devices 160 are disposed on the inner surface 121 of the counter substrate 120. The touch display panel 101 may be regarded as a kind of in-cell type touch display panel. A thickness of the touch display panel 101 may become thinner and the structure of the touch display panel 101 may be simplified because the touch sensing devices 160 and the touch driver circuit 130 are integrated in the structure of the display panel 101P.

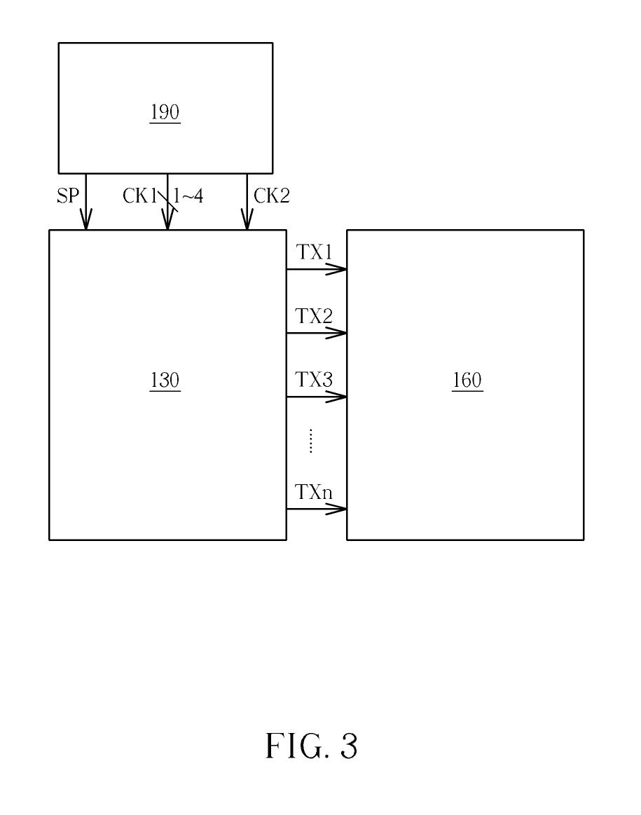

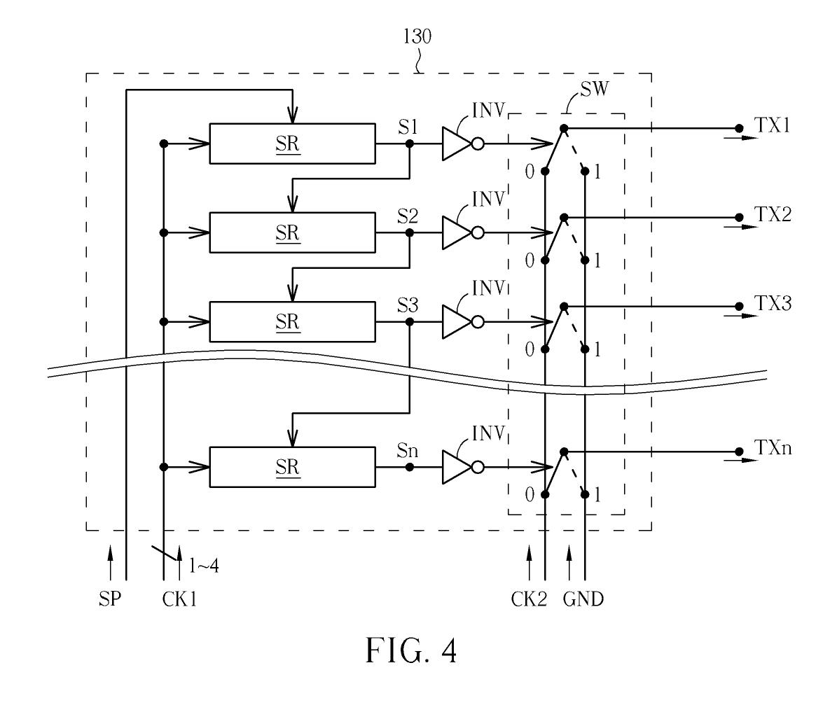

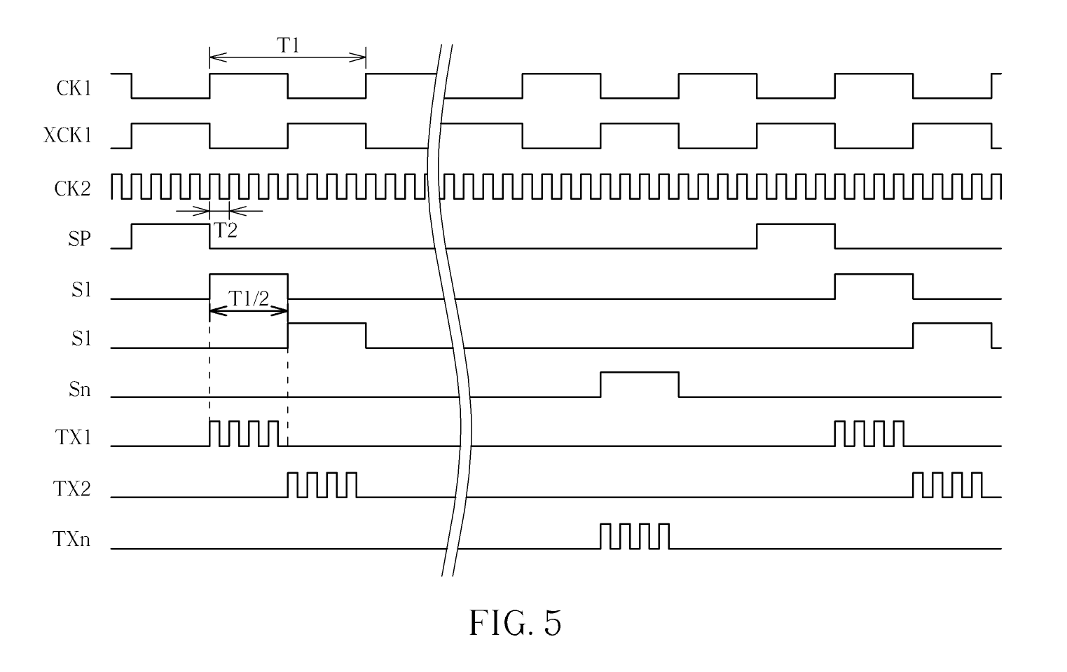

Please refer to FIG. 1, FIG. 3, FIG. 4, and FIG. 5. FIGS. 3-5 are schematic diagrams illustrating a touch driving method of the touch display panel according to the first preferred embodiment of the present invention. FIG. 3 is a schematic diagram illustrating a signal transmission relationship between the driver IC 190, the touch driver circuit 130, and the touch sensing devices 130. FIG. 4 is a schematic diagram illustrating a condition of signals processed in the touch driver circuit 130. FIG. 5 is a schematic diagram illustrating a timing of the scan driving signals. As shown in FIG. 3 and FIG. 4, the driver IC 190 may be used to generate signals, such as a first clock signal CK1, a second clock signal CK2, and a start pulse signal SP, to the touch driver circuit 130. A plurality of shift registers SR, a plurality of invertors INV, and a switch circuit SW may be disposed in the driver IC 190 so as to respectively generate a scan driving signal TX1, a scan driving signal TX2, a scan driving signal TX3 . . . and a scan driving signal TXn to each of the touch sensing devices 160. More specifically, as shown in FIG. 4 and FIG. 5, the first clock signal CK1 is inputted to each of the shift registers SR. The start pulse signal SP passes sequentially through each of the shift registers SR, and the first clock signals CK1 and a first inverted clock signal XCK1 are calculated to generate a pulse signal S1, a pulse signal S2, a pulse signal S3 . . . and a pulse signal Sn. The pulse signals S1-Sn are transmitted to the switch circuit SW after respectively passing through the corresponding invertors INV, and the pulse signals S1-Sn may be merged with the second clock signal CK2 and a ground signal GND so as to generate the scan driving signals TX1-TXn to each of the touch sensing devices (not shown in FIG. 4 and FIG. 5). The ground signal GND may also be replaced by a direct current (DC) signal. In this embodiment, the first clock signal CK1 and the second clock signal CK2 may respectively have a period T1 and a period T2. A frequency and a duration of one sensing signal from one touch sensing device may be controlled by tuning the period T1, and the amount of the pulse signals and the frequency of the pulse signal within one sensing signal from one touch sensing device may be controlled by tuning the period T2. Additionally, the scan driving signals TX1-TXn may be regarded as the touch transmitting signals in a mutual capacitance sensing driving method, but not limited thereto. It is worth noting that the shift registers SR, the invertors INV, and the switch circuit SW described above may be made according to layout designs of conductive lines and semiconductor devices, such as amorphous silicon semiconductor devices, poly silicon semiconductor devices, or oxide semiconductor devices, but not limited thereto.

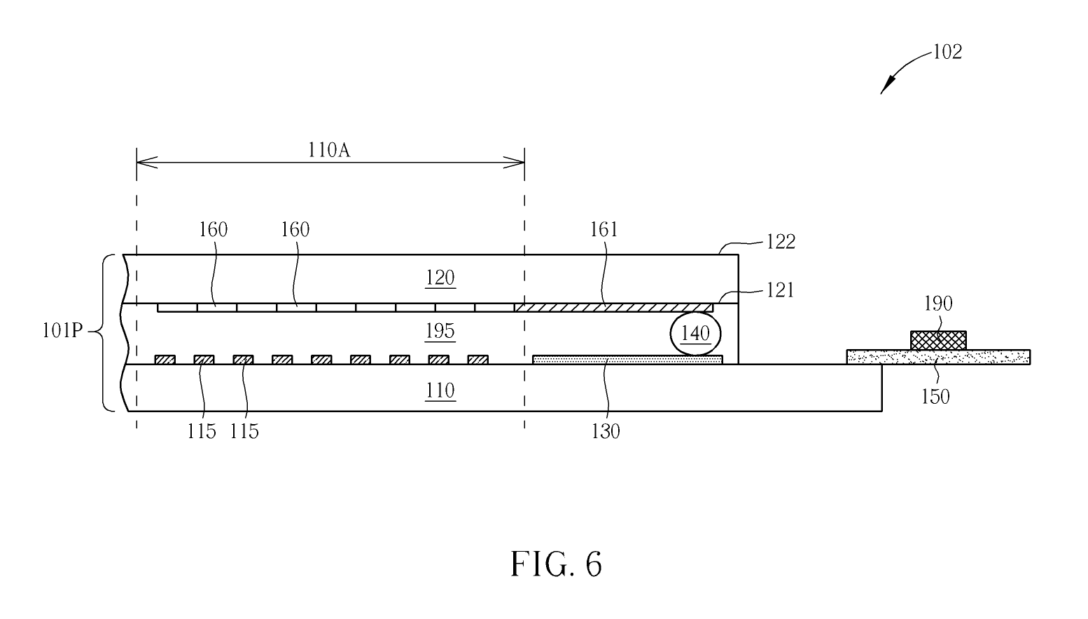

Please refer to FIG. 6. FIG. 6 is a schematic diagram illustrating a touch display panel according to a second preferred embodiment of the present invention. As shown in FIG. 6, the difference between a touch display panel 102 of this embodiment and the touch display panel 101 of the first preferred embodiment is that, in the touch display panel 102, the driver IC 190 is disposed on the circuit board 150. The signals generated from the driver IC 190 may be transmitted to the touch driver circuit 130 because the circuit board 150 is electrically connected to the array substrate 110. Apart from the allocations of the driver IC 190 in this embodiment, the other components, allocations, material properties, and touch driving methods of this embodiment are similar to those of the touch display panel 101 in the first preferred embodiment detailed above and will not be redundantly described.

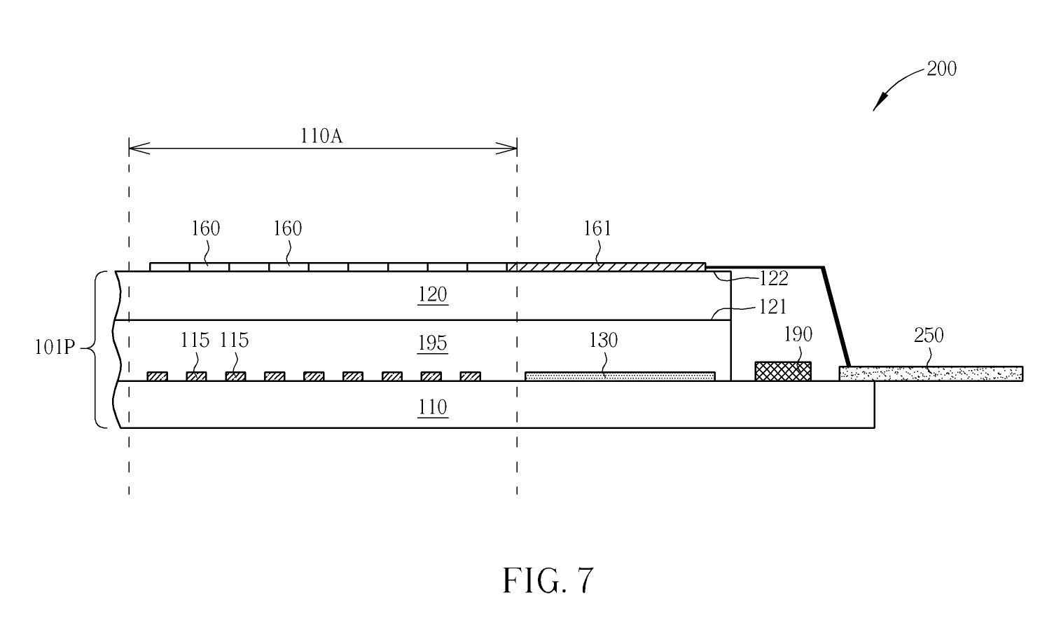

Please refer to FIG. 7. FIG. 7 is a schematic diagram illustrating a touch display panel according to a third preferred embodiment of the present invention. As shown in FIG. 7, the difference between a touch display panel 200 of this embodiment and the touch display panel 101 of the first preferred embodiment is that, in the touch display panel 200, the touch sensing devices 160 and the conductive circuit 161 are disposed on the outer surface 122 of the counter substrate 120, and the touch display panel 200 includes a circuit board 250 electrically connected to the touch sensing devices 160 and the array substrate 110. Therefore, the touch driver circuit 130 may be electrically connected to the touch sensing devices 160 through the circuit board 250. Apart from the circuit board 250 and the allocations of the touch sensing devices 160 and the conductive circuit 161 in this embodiment, the other components, allocations, material properties, and touch driving methods of this embodiment are similar to those of the touch display panel 101 in the first preferred embodiment detailed above and will not be redundantly described. It is worth noting that the touch display panel 200 in this embodiment may further include a cover lens (not shown) disposed on the outer surface 122 of the counter substrate 120 so as to cover and protect each of the touch sensing devices 160. In addition, the touch display panel 200 may be regarded as a kind of on-cell type touch display panel because the touch sensing devices 160 are disposed on the outer surface 122 of the counter substrate 120 in the touch display panel 200.

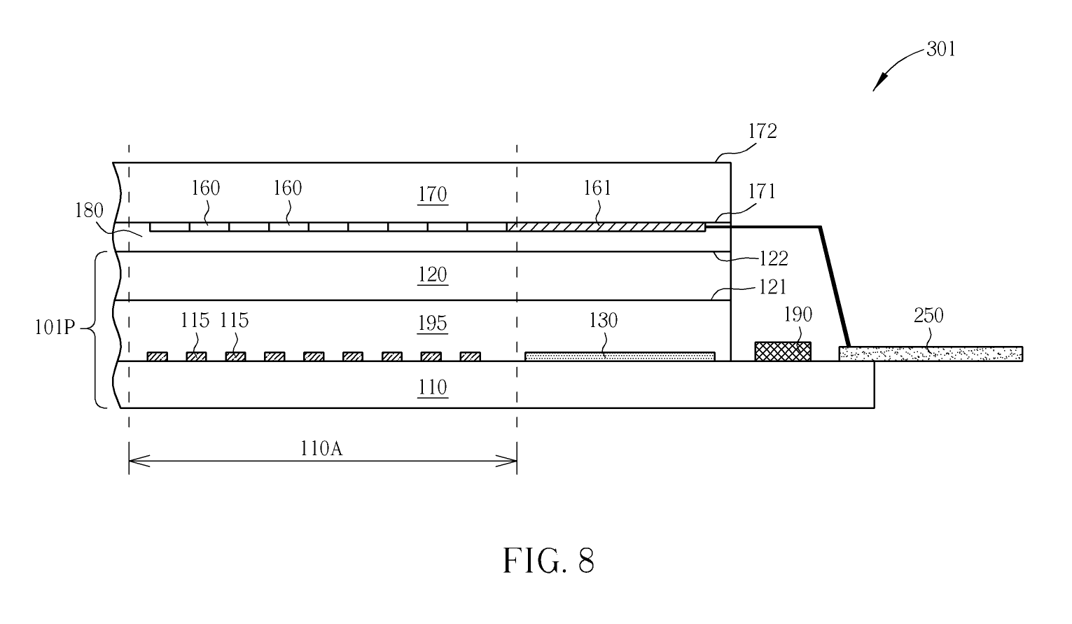

Please refer to FIG. 8. FIG. 8 is a schematic diagram illustrating a touch display panel according to a fourth preferred embodiment of the present invention. As shown in FIG. 8, the difference between a touch display panel 301 of this embodiment and the touch display panel 200 of the third preferred embodiment is that the touch display panel 301 further includes a touch substrate 170 and an adhesive layer 180. The touch substrate 170 is disposed on an outer surface 122 of the counter substrate 120. The adhesive layer 180 is disposed between the counter substrate 120 and the touch substrate 170, and the adhesive layer 180 is used to combine the counter substrate 120 and the touch substrate 170. Additionally, the touch substrate 170 has an inner surface 171 and an outer surface 172. The inner surface 171 faces the counter substrate 120, and the outer surface 172 faces the opposite direction from the counter substrate 120. The touch sensing devices 160 and the conductive circuit 161 are disposed on the inner surface 171 of the touch substrate 170, i.e. the touch sensing devices 160 and the conductive circuit 161 are disposed between the touch substrate 170 and the adhesive layer 180. The touch substrate 170 in this embodiment may include a cover lens so as to protect the touch sensing devices 160 as well, but not limited thereto. Apart from the touch substrate 170, the adhesive layer 180, the driving board 250, and the allocations of the touch sensing devices 160 and the conductive circuit 161 in this embodiment, the other components, allocations, material properties, and touch driving methods of this embodiment are similar to those of the touch display panel 101 in the first preferred embodiment detailed above and will not be redundantly described. It is worth noting that an outer surface 172 of the touch substrate 170 may be regarded as a touch sensing surface because the touch sensing devices 160 are disposed on the inner surface 171 of the touch substrate 170 in the touch display panel 301. The touch display panel 301 may be regarded as a kind of out-cell touch display panel. In addition, the total manufacturing yield may be enhanced because the touch sensing devices 160 may be formed on the touch substrate 170 before combining the touch substrate 170 with the counter substrate 120. The process conditions of the display panel 110P and the touch substrate 170 may be respectively controlled.

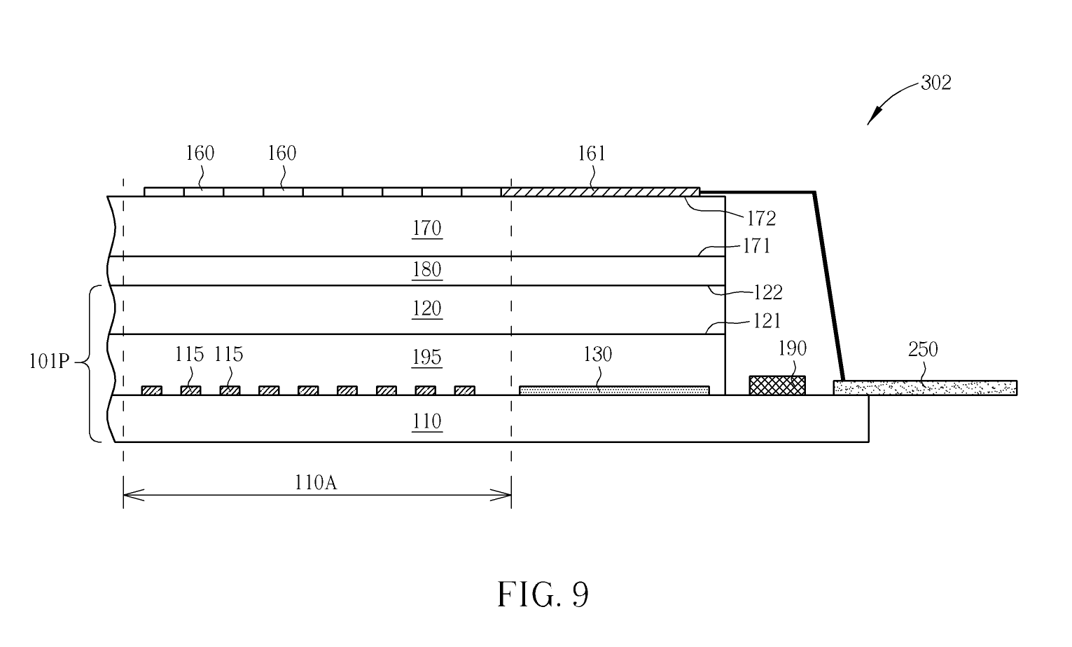

Please refer to FIG. 9. FIG. 9 is a schematic diagram illustrating a touch display panel according to a fifth preferred embodiment of the present invention. As shown in FIG. 9, the difference between a touch display panel 302 of this embodiment and the touch display panel 301 of the fourth preferred embodiment is that, in the touch display panel 302, the touch sensing devices 160 and the conductive circuit 161 are disposed on the outer surface 172 of the touch substrate 170. The touch driver circuit 130 may be electrically connected to the touch sensing devices 160 through the circuit board 250. Apart from the allocations of the touch sensing devices 160 and the conductive circuit 161 in this embodiment, the other components, allocations, material properties, and touch driving methods of this embodiment are similar to those of the touch display panel 301 in the fourth preferred embodiment detailed above and will not be redundantly described. It is worth noting that the touch display panel 302 in this embodiment may further include a cover lens (not shown) disposed on the outer surface 172 of the touch substrate 170 so as to cover and protect the touch sensing devices 160. Additionally, the touch display panel 302 in this embodiment may be regarded as a kind of out-cell touch display panel because the touch sensing devices 160 are disposed on the outer surface 172 of the touch substrate 170, and the touch sensing devices 160 may be formed on the outer surface 172 of the touch substrate 170 before combining the counter substrate 120 with the touch substrate 170 by the adhesive layer 180.

Besides, each of the touch sensing devices according to the above embodiments may be a patterned transparent conductive layer, a metallic layer or multiple metallic layers composed of at least two kinds of materials, or a combination of two of them. The pattern of the metallic layer may be a metal mesh pattern having a trace width of 1-5 um. The metal mesh pattern may be a single layered pattern or a multi-layered pattern, where a single layered pattern may be formed by a single material (such as copper) and a multi-layered pattern may be formed by a stack of at least two metal layers (such as Mo/Al/Mo). The multi-layered pattern may be referred to as a structure where two conductive patterns are insulated from each other by a complete or a patterned dielectric layer. Certainly, the composition and material of the stacked layers are not limited to the above examples. Note the aforementioned concepts may be applied to all embodiments of the invention.

To summarize the above descriptions, in the touch display panel of the present invention, the touch driver circuit is disposed on the array substrate so as to simplify the design of the touch driver IC. The purpose of lowering the cost of the touch driver IC may be accordingly achieved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch display panel, comprising:
a display panel, comprising an array substrate;
a plurality of touch sensing devices; and
a touch driver circuit, disposed on the array substrate, wherein the touch driver circuit is electrically connected to the touch sensing devices, and the touch driver circuit is employed to provide at least one scan driving signal to the touch sensing devices.

2. The touch display panel of claim 1, wherein the display panel further comprises a counter substrate disposed oppositely to the array substrate, the counter substrate has an inner surface facing the array substrate, and the touch sensing devices are disposed on the inner surface of the counter substrate.

3. The touch display panel of claim 2, further comprising at least one connecting device disposed between the array substrate and the counter substrate, wherein the touch driver circuit is electrically connected to the touch sensing devices through the connecting device.

4. The touch display panel of claim 1, wherein the display panel further comprises a counter substrate and a circuit board, the counter substrate is disposed oppositely to the array substrate, and the touch driver circuit is electrically connected to the touch sensing devices through the circuit board.

5. The touch display panel of claim 4, wherein the counter substrate has an outer surface facing the opposite direction from the array substrate, and the touch sensing devices are disposed on the outer surface of the counter substrate.

6. The touch display panel of claim 4, further comprising a touch substrate and an adhesive layer, wherein the touch substrate is disposed on the counter substrate, and the adhesive layer is disposed between the counter substrate and the touch substrate.

7. The touch display panel of claim 6, wherein the touch substrate has an inner surface facing the counter substrate, the touch sensing devices are disposed on the inner surface of the touch substrate, and the touch sensing devices are disposed between the touch substrate and the adhesive layer.

8. The touch display panel of claim 6, wherein the touch substrate has an outer surface facing the opposite direction from the counter substrate, and the touch sensing devices are disposed on the outer surface of the touch substrate.

9. The touch display panel of claim 1, wherein the array substrate has an active display region, and the touch driver circuit is disposed outside the active display region.

10. The touch display panel of claim 1, wherein the display panel includes a liquid crystal display panel, an organic electroluminescent display panel, or an electronic paper display panel.

11. The touch display panel of claim 1, wherein the array substrate includes an amorphous silicon thin film transistor array substrate, a poly silicon thin film transistor array substrate, or an oxide semiconductor thin film transistor array substrate.

12. The touch display panel of claim 1, wherein the touch sensing devices are formed as metal mesh pattern.
